(19) United States
(12) Patent Application Publication
(10) Pub. No.: US 2018/0091009 A1
(43) Pub. Date: Mar. 29, 2018

(54) SYNCHRONOUS ROTATING ELECTRIC MACHINE

(71) Applicant: DENSO CORPORATION, Kariya-city (JP)

(72) Inventor: Shin KUSASE, Kariya-city (JP)

(73) Assignee: DENSO CORPORATION, Kariya-city (JP)

(21) Appl. No.: 15/708,443

(22) Filed: Sep. 19, 2017

(30) Foreign Application Priority Data
Sep. 29, 2016 (JP) 2016-191958

(51) Int. Cl. H02K 1/27

(52) U.S. Cl. CPC H02K 1/2773; H02P 3/14

(57) ABSTRACT

A synchronous rotating electric machine includes an armature and a rotor. The armature has an armature coil wound on an armature core. The rotor has permanent magnets embedded in a rotor core so as to be spaced from one another in a circumferential direction of the rotor core. The rotor has a structure such that: the rotor core has yoke portions each of which is formed between one circumferentially-adjacent pair of the permanent magnets; and all of the permanent magnets are magnetized in the same magnetization direction along the circumferential direction of the rotor core so that for each circumferentially-facing pair of circumferential side surfaces of the permanent magnets, the polarities of the circumferential side surfaces of the circumferentially-facing pair are opposite to each other. With the above structure, flow of magnetic flux generated by the permanent magnets changes depending on whether electric current is flowing in the armature coil.

### CROSS-REFERENCE TO RELATED APPLICATION

This application is based on and claims priority from Japanese Patent Application No. 2016-191958 filed on Sep. 29, 2016, the content of which is hereby incorporated by reference in its entirety into this application.

### BACKGROUND

### 1. Technical Field

The present invention relates to synchronous rotating electric machines which include, at least, an armature and a rotor, but no field winding.

### 2. Description of Related Art

As high-performance permanent magnet motors, both SPM (Surface Permanent Magnet) motors and IPM (Interior Permanent Magnet) motors have been used. The main difference in structure between SPM motors and IPM motors is that SPM motors have permanent magnets attached on a surface of a rotor core, whereas IPM motors have permanent magnets embedded in a rotor core.

In SPM motors, an armature coil is always subject to magnetic flux generated by permanent magnets (to be simply referred to as permanent magnet magnetic flux hereinafter). Therefore, the electromotive force generated in the armature coil increases with increase in the rotational speed of a rotor. Moreover, with increase in the electromotive force, the armature current supplied to flow through the armature coil is suppressed, resulting in a decrease in the motor output.

In comparison, in IPM motors, the permanent magnet magnetic flux has less influence on an armature coil. Therefore, it is possible to perform a field weakening control to suppress the electromotive force generated in the armature coil, thereby preventing the motor output from being decreased with increase in the rotational speed of a rotor. Accordingly, employing IPM motors is now the mainstream in cases where it is necessary to perform variable speed operation in a wide rotational speed range.

However, in IPM motors, though it is possible to suppress that portion of the permanent magnet magnetic flux which crosses the armature coil (to be simply referred to as main magnetic flux hereinafter), there still remains in an armature core the other portion of the permanent magnet magnetic flux than the main magnetic flux. The remaining portion of the permanent magnet magnetic flux causes iron loss to occur in the armature core.

Japanese Patent Application Publication No. JP2012080615A discloses a variable magnetic flux motor. The variable magnetic flux motor includes a stator (or armature), a rotor and an actuator. The stator includes a stator core and a stator coil wound on the stator core. The rotor is disposed in radial opposition to the stator. The rotor includes a rotor core and a plurality of permanent magnets embedded in the rotor core. The actuator is configured to change the relative axial position of the rotor to the stator and thereby adjust the permanent magnet magnetic flux crossing the stator coil. Moreover, in the variable magnetic flux motor, the rotor further includes a magnetic flux blocking member that is provided at least on the radially stator side of the permanent magnets to block, when a portion of the rotor is axially exposed from the stator, the permanent magnet magnetic flux from axially leaking from the exposed portion of the rotor to the stator.

In the above variable magnetic flux motor, the permanent magnets are embedded in pairs in the rotor core. Each pair of the permanent magnets is arranged to form a substantially V-shape that opens toward the stator side. For each pair of the permanent magnets, that portion of the rotor core which is located between the pair of the permanent magnets and radially faces the stator is magnetized by the pair of the permanent magnets into a magnetic pole portion (either an N pole portion or an S pole portion). Therefore, as in the case of SPM motors, the stator coil (or armature coil) is always subject to the magnetic flux that flows from the magnetic pole portions of the rotor core to the stator. Consequently, the electromotive force generated in the stator coil increases with increase in the rotational speed of the rotor. Further, with increase in the electromotive force, the electric current supplied to flow through the stator coil is suppressed, resulting in a decrease in the motor output.

Moreover, in the above variable magnetic flux motor, it may be possible to provide a field winding in the rotor and weaken the permanent magnet magnetic flux with magnetic flux that is generated by supplying field current to the field winding (to be simply referred to as field winding magnetic flux hereinafter). However, in this case, it is necessary to employ a controller that controls both the permanent magnet magnetic flux and the field winding magnetic flux, thereby increasing the manufacturing cost. Moreover, the permanent magnet magnetic flux is much stronger than the field winding magnetic flux. Therefore, even if the field current is set to be high, it would still be difficult to sufficiently weaken the permanent magnet magnetic flux with the field winding magnetic flux.

In addition, it may be possible to generate the field winding magnetic flux almost at the same level as the permanent magnet magnetic flux by increasing the number of turns of the field winding and/or the cross-sectional area of the field winding. However, in this case, the size of the field winding and thus the size of the entire motor would be increased.

### SUMMARY

According to an exemplary embodiment, there is provided a synchronous rotating electric machine which includes an armature and a rotor. The armature includes an armature core and an armature coil wound on the armature core. The rotor includes a rotor core disposed in radial opposition to the armature core and a plurality of permanent magnets embedded in the rotor core so as to be spaced from one another in a circumferential direction of the rotor core. The rotor has a structure such that: the rotor core has a plurality of yoke portions each of which is formed between one circumferentially-adjacent pair of the permanent magnets; and all of the permanent magnets are magnetized in the same magnetization direction along the circumferential direction of the rotor core so that for each circumferentially-facing pair of circumferential side surfaces of the permanent magnets, the polarities of the circumferential side surfaces of the circumferentially-facing pair are opposite to each other. With the above structure, flow of magnetic flux generated by the permanent magnets changes depending on whether electric current is flowing in the armature coil.

Consequently, it becomes possible to change the flow of the permanent magnet magnetic flux (i.e., the magnetic flux generated by the permanent magnets) in the synchronous rotating electric machine only by controlling supply of electric current to the armature coil without providing a field winding in the rotor. As a result, it becomes possible to reduce the parts count and thus the manufacturing cost of the synchronous rotating electric machine; it also becomes possible to minimize the size of the rotor and thus the size of the entire synchronous rotating electric machine. Moreover, it is possible to adjust the amount of the permanent magnet magnetic flux crossing the armature coil by changing the magnetomotive force generated in the armature coil through changing the amplitude of the electric current supplied to the armature coil. Accordingly, compared to conventional rotating electric machines where the armature coil is always subject to the permanent magnet magnetic flux, it is possible to secure a high output (e.g., high torque) of the synchronous rotating electric machine in a wide rotational speed range by suitably adjusting the amount of the permanent magnet magnetic flux crossing the armature coil.

### BRIEF DESCRIPTION OF THE DRAWINGS

The present invention will be understood more fully from the detailed description given hereinafter and from the accompanying drawings of one exemplary embodiment, which, however, should not be taken to limit the invention to the specific embodiment but are for the purpose of explanation and understanding only.

In the accompanying drawings:

FIG. 1 is a schematic cross-sectional view of a synchronous rotating electric machine according to an embodiment;

FIG. 2 is a schematic cross-sectional view, taken along the line II-II in FIG. 1, of part of the synchronous rotating electric machine;

FIG. 3 is a schematic view illustrating the definition of both a magnetic pole angle and a yoke angle in a rotor of the synchronous rotating electric machine;

FIG. 4 is a schematic view illustrating the flow of magnetic flux in the synchronous rotating electric machine when no current is flowing in an armature coil of the machine;

FIG. 5 is a schematic view illustrating the flow of magnetic flux in the synchronous rotating electric machine when armature current is flowing in the armature coil;

FIG. 6 is a graphical representation illustrating both the change in main magnetic flux with electrical angle when no current is flowing in the armature coil and the change in main magnetic flux with electrical angle when the armature current is flowing in the armature coil;

FIG. 7 is a graphical representation illustrating the relationship between a pole arc ratio and the torque of the synchronous rotating electric machine; and

FIG. 8 is a graphical representation illustrating the relationship between a width ratio and the torque of the synchronous rotating electric machine.

### DESCRIPTION OF EMBODIMENT

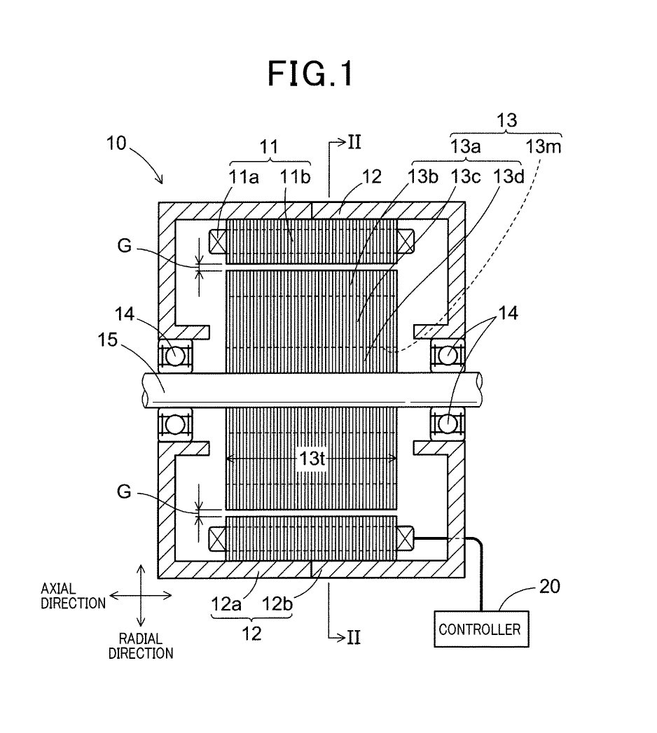

An exemplary embodiment will be described hereinafter with reference to FIGS. 1-8.

FIG. 1 shows the overall configuration of a synchronous rotating electric machine 10 according to the exemplary embodiment.

In the present embodiment, the synchronous rotating electric machine 10 is configured as an inner-rotor IPM motor for use in, for example, a motor vehicle.

As shown in FIG. 1, the synchronous rotating electric machine 10 includes an armature (or stator) 11, a rotor 13, a pair of bearings 14 and a rotating shaft 15, all of which are received in a frame (or housing) 12. Moreover, the synchronous rotating electric machine 10 also includes a controller 20 which may be provided either outside the frame 12 (see FIG. 1) or inside the frame 12 (not shown). In addition, it should be noted that the synchronous rotating electric machine 10 includes no field winding.

The frame 12 may be formed of any suitable material into any suitable shape. The frame 12 supports and fixes thereto, at least, the armature 11. Moreover, the frame 12 rotatably supports the rotating shaft 15 via the pair of bearings 14.

For example, in the present embodiment, the frame 12 is formed of a nonmagnetic material and includes a pair of cup-shaped frame pieces 12a and 12b which are fixed together at the open ends thereof. In addition, the frame pieces 12a and 12b may be fixed together by fixing members (e.g., bolts, nuts or fixing pins) or by welding. It should be appreciated that the frame 12 may also be formed into one piece.

The armature 11 includes an armature coil (or stator coil) 11a and an armature core (or stator core) 11b on which the armature coil 11a is wound.

In the present embodiment, the armature coil 11a is configured as a three-phase coil. The armature coil 11a may be formed of either a single continuous conductor wire or a plurality of conductor wires (or conductor segments) that are electrically connected with each other.

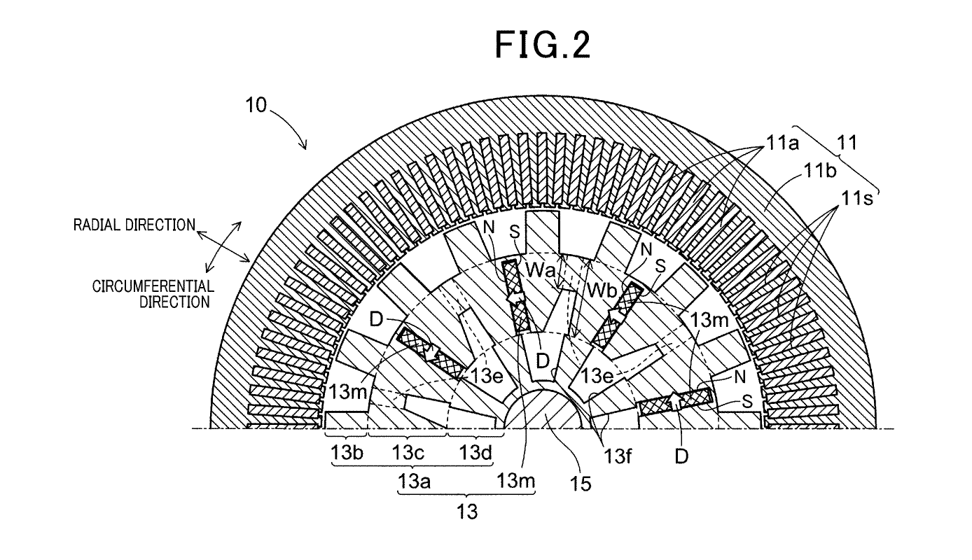

As shown in FIG. 2, the armature core 11b is annular (or hollow cylindrical) in shape and has a plurality of slots 11s formed therein. Each of the slots 11s extends in an axial direction of the armature core 11b so as to penetrate the armature core 11b in the axial direction. Moreover, the slots 11s are spaced from one another in a circumferential direction of the armature core 11b at predetermined intervals.

The armature core 11b may be formed of any suitable material using any suitable method. For example, in the present embodiment, the armature core 11b is formed by laminating a plurality of magnetic steel sheets in the axial direction of the armature core 11b.

The armature coil 11a is wound on the armature core 11b so as to be received in the slots 11s. In addition, the armature coil 11a may be wound in any suitable manner, such as full-pitch winding, short-pitch winding, concentrated winding or distributed winding.

The armature coil 11a may have any suitable cross-sectional shape, such as a rectangular, circular or triangular cross-sectional shape. For example, the armature coil 11a may have a rectangular cross-sectional shape and be received in a plurality (e.g., four) layers in each of the slots 11s. Moreover, the armature coil 11a may extend across a predetermined number of the slots 11s at a predetermined angular pitch; in the course of the extension, there may be formed a crank-shaped part by which the armature coil 11a is radially offset.

The rotor 13 is disposed radially inside the armature core 11b so as to face a radially inner periphery of the armature core 11b. The rotor 13 is fixed on the rotating shaft 15 so as to rotate together with the rotating shaft 15. The configuration of the rotor 13 will be described in detail later.

Referring back to FIG. 1, between the rotor 13 and the armature 11, there is formed a radial gap G. The radial gap G may be set to any suitable value such that magnetic flux can flow between the rotor 13 and the armature 11.

The controller 20 performs, for example, a power running control and a regenerative braking control. In the power running control, the controller 20 controls multi-phase (e.g., three-phase in the present embodiment) alternating current supplied to the armature coil 11a. In the regenerative braking control, the controller 20 controls the output of electromotive force generated in the armature coil 11a to, for example, a rechargeable battery or an electrical load provided in the vehicle.

Next, the configuration of the rotor 13 will be described in detail with reference to FIG. 2.

In the present embodiment, the rotor 13 includes a cylindrical rotor core 13a and a plurality of permanent magnets 13m, but no field winding.

The rotor core 13a has the permanent magnets 13m embedded therein at equal circumferential intervals. The rotor core 13a includes a plurality of magnetic pole portions 13b, a plurality of yoke portions 13c and a hub portion 13d.

The rotor core 13a may be formed of any suitable material using any suitable method. For example, in the present embodiment, the rotor core 13a is formed by laminating a plurality of magnetic steel sheets in the axial direction of the rotor core 13a. That is, all of the magnetic pole portions 13b, the yoke portions 13c and the hub portion 13d of the rotor core 13a are integrally formed into one piece. In addition, the rotor core 13a has a predetermined axial length (or lamination thickness) 13t (see FIG. 1).

In the present embodiment, the permanent magnets 13m each have the shape of a quadrangular prism with a rectangular cross section. The permanent magnets 13m are embedded in the rotor core 13a in a radial fashion so that for each of the permanent magnets 13m, the longer sides of the rectangular cross section of the permanent magnet 13m extend parallel to a radial direction of the rotor core 13a. Moreover, as shown in FIG. 2, all of the permanent magnets 13m are magnetized in the same magnetization direction D along the circumferential direction of the rotor core 13a so that for each circumferentially-facing pair of circumferential side surfaces of the permanent magnets 13m, the polarities of the circumferential side surfaces of the circumferentially-facing pair are opposite to each other.

The number of the permanent magnets 13m embedded in the rotor core 13a may be suitably set according to the rating and design specification of the synchronous rotating electric machine 10. In the present embodiment, the number of the permanent magnets 13m is set to, for example, 8.

The magnetic pole portions 13b are each formed as a protrusion protruding from the yoke portions 13c toward the armature 11 (more specifically, the armature core 11b). When the magnetic pole portions 13b function as magnetic poles during operation of the synchronous rotating electric machine 10, the polarities of the magnetic poles alternate between N (North) and S (South) in the circumferential direction of the rotor core 13a.

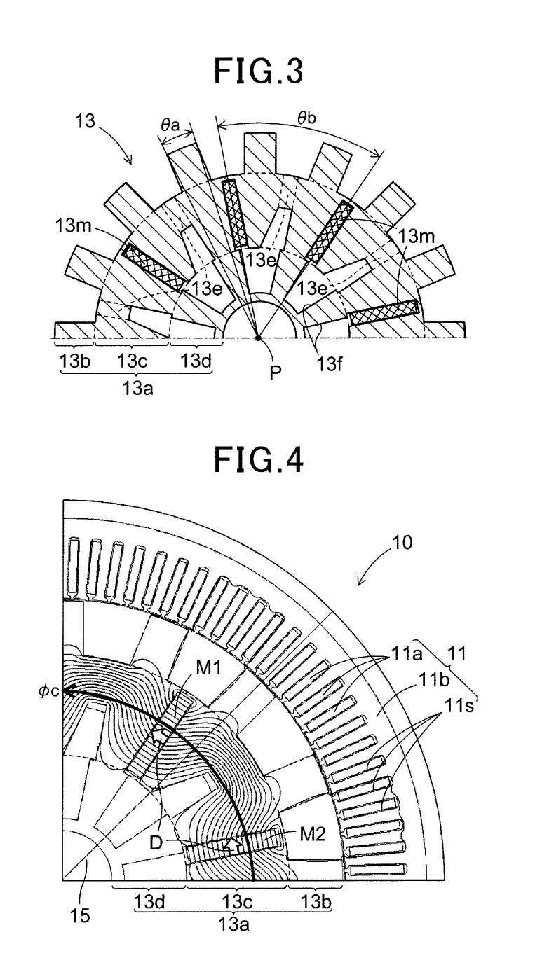

The number, shape and size of the magnetic pole portions 13b may be suitably set according to the rating and design specification of the synchronous rotating electric machine 10. In the present embodiment, the number of the magnetic pole portions 13b (i.e., the number of the magnetic poles) is set to, for example, 16. In addition, each of the magnetic pole portions 13b has a magnetic pole angle θa (see FIG. 3) that represents the angular range within which a distal end surface (or radially outer end surface in the present embodiment) of the magnetic pole portion 13b circumferentially extends. The setting of the magnetic pole angle θa will be described in detail later.

Each of the yoke portions 13c is formed between one circumferentially-adjacent pair of the permanent magnets 13m so that magnetic flux can flow between the circumferentially-adjacent pair of the permanent magnets 13m through the yoke portion 13c. Moreover, each of the yoke portions 13c has two magnetic pole portions 13b protruding therefrom radially outward. That is, each of the yoke portions 13c has root parts of two magnetic pole portions 13b connected therewith. In addition, each of the yoke portions 13c has a yoke angle θb (see FIG. 3) that represents the angular range within the yoke portion 13c is formed; each of the yoke portions 13c also has a yoke width Wb (see FIG. 2) that represents a radial width of the yoke portion 13c. The setting of the yoke angle θb and the yoke width Wb will be described in detail later.

Each of the yoke portions 13c has a narrow part 13e at which the yoke portion 13c is radially narrowed to limit the amount of magnetic flux circumferentially flowing through the yoke portion 13c. The narrow part 13e is located substantially equidistant from the circumferentially-adjacent pair of the permanent magnets 13m between which the yoke portion 13c is formed. The narrow part 13e has a narrow width Wa (see FIG. 2) that represents a radial width of the narrow part 13e. The setting of the narrow width Wa will be described in detail later.

The hub portion 13d has an annular part fixed on the rotating shaft 15 and a plurality of fan-shaped spoke parts that extend from the annular part in a radial fashion so as to be respectively connected to the yoke portions 13c.

Moreover, with the above formation of the narrow parts 13e in the respective yoke portions 13c and the spoke parts in the hub portion 13d, there are formed a plurality of void spaces 13f in the rotor core 13a. Each of the void spaces 13f constitutes a magnetic flux barrier to block magnetic flux from flowing therethrough. In addition, the void spaces 13f may be filled with a nonmagnetic material (e.g., resin) provided that it is still possible to block magnetic flux from flowing through the spaces 13f.

Referring to FIG. 3, in the present embodiment, the magnetic pole angle θa is defined, for each of the magnetic pole portions 13b of the rotor core 13a, as the angle between two imaginary lines that extend, on a plane perpendicular to the central axis P of the rotor core 13a, from the central axis P respectively through opposite circumferential ends of the distal end surface (or radially outer end surface) of the magnetic pole portion 13b. On the other hand, the yoke angle θb is defined, for each of the yoke portions 13c of the rotor core 13a, as the angle between two imaginary lines that extend, on the plane perpendicular to the central axis P of the rotor core 13a, from the central axis P respectively through the centers of the two circumferentially-adjacent permanent magnets 13m between which the yoke portion 13c is formed. In addition, the yoke angle θb also represents the angular range corresponding to one cycle (i.e., 360°) in electrical angle.

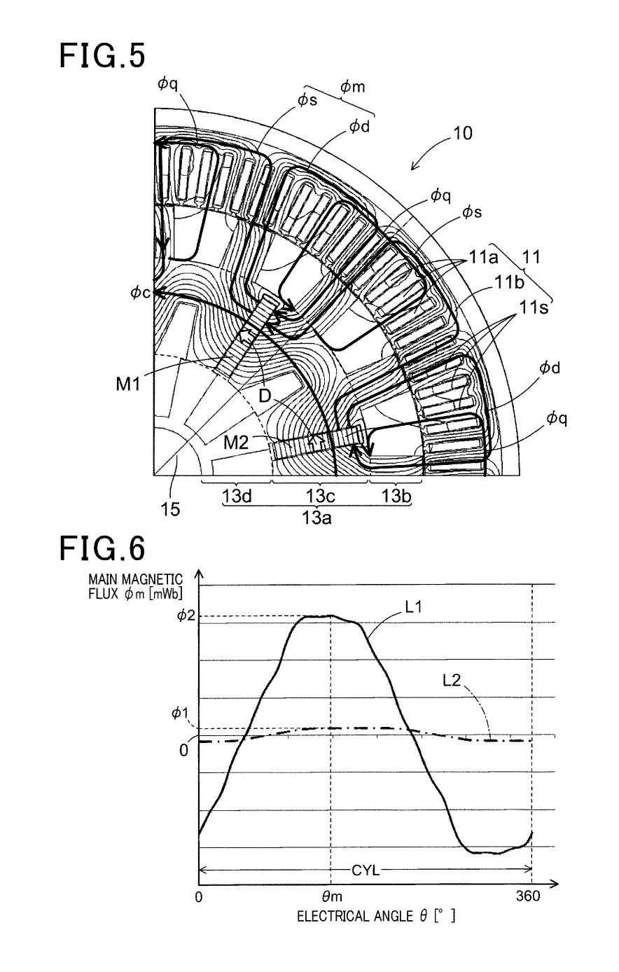

Next, the flow of magnetic flux in the synchronous rotating electric machine 10 according to the present embodiment will be described with reference to FIGS. 4 and 5.

It should be noted that: in FIGS. 4 and 5, there is schematically shown only part of the synchronous rotating electric machine 10 which corresponds to 90° in mechanical angle; and the two permanent magnets 13m shown therein are respectively designated by M1 and M2 for the sake of convenience of explanation.

In the synchronous rotating electric machine 10 according to the present embodiment, the flow of magnetic flux changes depending on whether armature current (or three-phase alternating current) is flowing in the armature coil 11a.

Specifically, referring first to FIG. 4, when no current is flowing in the armature coil 11a, no magnetomotive force is generated in the armature coil 11a. As described previously, in the present embodiment, all of the permanent magnets 13m embedded in the rotor core 13a are magnetized in the same magnetization direction D along the circumferential direction of the rotor core 13a. Therefore, the magnetic flux emanating from the permanent magnet M2 flows to the permanent magnet M1 through the yoke portions 13c of the rotor core 13a formed between the permanent magnets M1 and M2. Further, the magnetic flux emanating from the permanent magnet M1 flows to the permanent magnet 13m (not shown) which is located immediately counterclockwise (or downstream) of the permanent magnet M1 through the yoke portions 13c of the rotor core 13a formed between the permanent magnet M1 and the not-shown permanent magnet 13m. In this way, the magnetic flux generated by all of the permanent magnets 13m circumferentially circulates in the rotor core 13a, forming circulating magnetic flux φc. In this case, the circulating magnetic flux φc corresponds to “permanent magnet magnetic flux” (i.e., the magnetic flux generated by the permanent magnets 13m) and the magnetic path along which the circulating magnetic flux φc circulates corresponds to “first magnetic circuit”.

In addition, in this case, the amount of leakage magnetic flux from the permanent magnets 13m to the armature core 11b is so small as to be negligible; accordingly, the magnetomotive force generated in the armature core 11b by the leakage magnetic flux is also negligible.

On the other hand, referring to FIG. 5, when armature current is flowing in the armature coil 11a, magnetomotive force is generated in the armature coil 11a. With generation of the magnetomotive force, d-axis magnetic flux φd that depends on d-axis current and q-axis magnetic flux φq that depends on q-axis current flow between the armature 11 and the rotor 13.

Moreover, as shown in FIG. 5, the magnetic flux generated by the permanent magnets 13m includes both circulating magnetic flux φc and shunt magnetic flux φs. The circulating magnetic flux φc circumferentially circulates in the rotor core 13a as in the case where no current is flowing in the armature coil 11a. However, the amount of the circulating magnetic flux φc is reduced by the amount of the shunt magnetic flux φs in comparison with the case where no current is flowing in the armature coil 11a. The shunt magnetic flux φs flows along a different magnetic path from the circulating magnetic flux φc. For example, the shunt magnetic flux φs emanating from the permanent magnet M2 flows, through the yoke portion 13c and the magnetic pole portion 13b both of which are located immediately counterclockwise (or downstream) of the permanent magnet M2, to the armature core 11b; then the shunt magnetic flux φs flows from the armature core 11b to the permanent magnet M1 through the magnetic pole portion 13b and the yoke portion 13c both of which are located immediately clockwise (or upstream) of the permanent magnet M1. Further, the shunt magnetic flux φs emanating from the permanent magnet M1 flows, through the yoke portion 13c and the magnetic pole portion 13b both of which are located immediately counterclockwise of the permanent magnet M1, to the armature core 11b; then the shunt magnetic flux φs flows from the armature core 11b to the permanent magnet 13m (not shown) which is located immediately counterclockwise of the permanent magnet M1 through the magnetic pole portion 13b and the yoke portion 13c both of which are located immediately clockwise of the not-shown permanent magnet 13m. In this way, the shunt magnetic flux φs flows between all of the permanent magnets 13m through the yoke portions 13c and the magnetic pole portions 13b of the rotor core 13a and the armature core 11b. In this case, the circulating magnetic flux φc and the shunt magnetic flux φs together correspond to “permanent magnet magnetic flux” (i.e., the magnetic flux generated by the permanent magnets 13m) and the magnetic path along which the shunt magnetic flux φs flows corresponds to “second magnetic circuit”.

The shunt magnetic flux φs is caused by the magnetomotive force that is generated upon supply of the armature current to the armature coil 11a. More specifically, part of the magnetic flux generated by the permanent magnets 13m is attracted, by the magnetomotive force generated in the armature coil 11a, to flow to the armature core 11b through the yoke portions 13c and the magnetic pole portions 13b of the rotor core 13a, forming the shunt magnetic flux φs. Moreover, the magnetomotive force changes with change in the amplitude of the armature current supplied to the armature coil 11a. Therefore, the amount of the shunt magnetic flux φs can be adjusted by changing the amplitude of the armature current.

The shunt magnetic flux φs flowing to the armature core 11b crosses the armature coil 11a, generating electromotive force. Moreover, the shunt magnetic flux φs flows between the magnetic pole portions 13b of the rotor core 13a and the armature core 11b, generating torque (i.e., magnet torque). Thus, the main magnetic flux φm includes both the d-axis magnetic flux φd and the shunt magnetic flux φs. That is, φm=φd+φs. Here, the main magnetic flux φm denotes the total magnetic flux which crosses the armature coil 11a and flows between the magnetic pole portions 13b of the rotor core 13a and the armature core 11b (see FIG. 5).

Next, the magnetic flux characteristics of the synchronous rotating electric machine 10 according to the present embodiment will be described with reference to FIG. 6.

In FIG. 6, the horizontal axis represents electrical angle θ and the vertical axis represents the main magnetic flux φm. A characteristic line L1, which is drawn as a continuous line, represents the change in the main magnetic flux φm for one cycle of electrical angle θ (i.e., 0°≦θ<360°) when the armature current is flowing in the armature coil 11a. A characteristic line L2, which is drawn as a one-dot chain line, represents the change in the main magnetic flux φm for one cycle of electrical angle θ when no current is flowing in the armature coil 11a.

As shown in FIG. 6, when the armature current is flowing in the armature coil 11a, the main magnetic flux φm has its maximum value φ2 at a value φm of electrical angle θ. In comparison, when no current is flowing in the armature coil 11a, the main magnetic flux φm has a value φ1 at the value φm of electrical angle θ.

In the present embodiment, an outside diameter of the synchronous rotating electric machine 10 is set to, for example, 128 mm. The lamination thickness (or axial length) 13t of the rotor core 13a is set to, for example, 32 mm. The armature current is set to, for example, 100 Arms. In this case, the magnetic flux variation ratio φr, which is defined as φ2/φ1, is approximately equal to 20. That is, φr=φ2/φ1≈20.

In comparison, in conventional electric motors including the variable magnetic flux motor disclosed in Japanese Patent Application Publication No. JP2012080615A, the magnetic flux variation ratio φr is not greater than 2. That is, φr≦2.

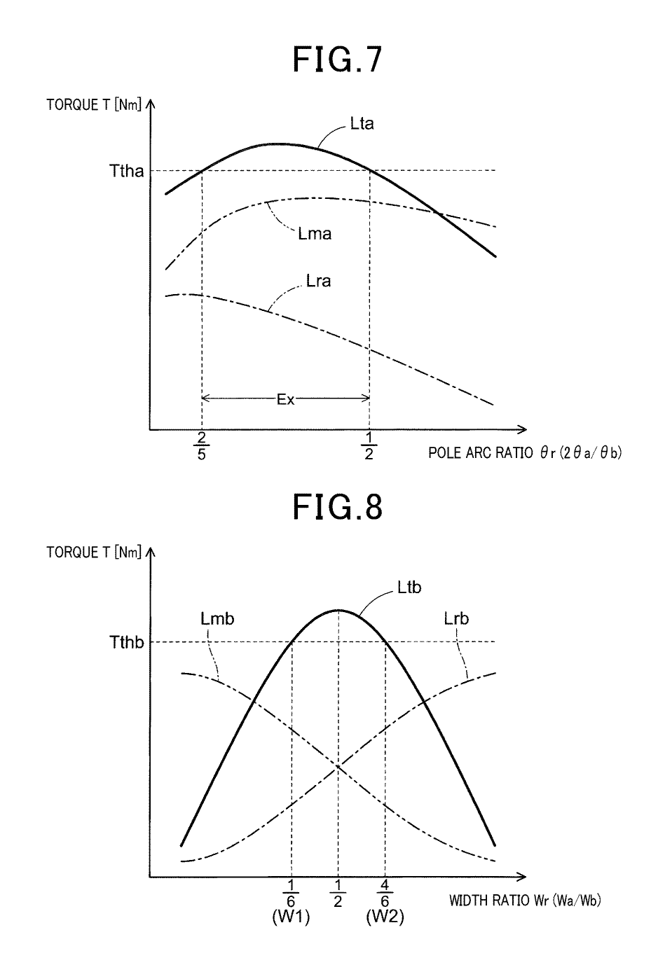

Next, the torque characteristics of the synchronous rotating electric machine 10 according to the present embodiment will be described with reference to FIGS. 7 and 8.

FIG. 7 illustrates the relationship between a pole arc ratio θr and the torque T of the synchronous rotating electric machine 10.

The pole arc ratio θr is the ratio of twice the magnetic pole angle θa to the yoke angle θb (see FIG. 3). That is, θr=2θa/θb. The torque T is proportional to the sum of reluctance torque Tr and magnet torque Tm. That is, T∝(Tr+Tm).

In FIG. 7, the horizontal axis represents the pole arc ratio θr and the vertical axis represents the torque T. A characteristic line Lta, which is drawn as a continuous line, represents the change in the torque T with the pole arc ratio θr. A characteristic line Lra, which is drawn as a one-dot chain line, represents the change in the reluctance torque Tr with the pole arc ratio θr. A characteristic line Lma, which is drawn as a two-dot chain line, represents the change in the magnet torque Tm with the pole arc ratio θr.

The reluctance torque Tr is proportional to the difference between the d-axis magnetic flux φd and the q-axis magnetic flux φq. That is, Tr∝(φd−φq). As shown in FIG. 7, when the pole arc ratio θr is small, the reluctance torque Tr slightly increases with the pole arc ratio θr. Then, the reluctance torque Tr decreases with increase in the pole arc ratio θr.

The magnet torque Tm is proportional to the main magnetic flux φm. That is, Tm∝φm. In addition, as described previously, φm=φd+φs. As shown in FIG. 7, the magnet torque Tm first increases with the pole arc ratio θr. Then, after the pole arc ratio θr exceeds ½, leakage magnetic flux increases and thus the magnet torque Tm decreases slowly with the pole arc ratio θr.

It can be seen from FIG. 7 that when the pole arc ratio θr is in a predetermined range Ex, the torque T is higher than or equal to a threshold value Ttha. In the present embodiment, the predetermined range Ex has its lower limit set to ⅖ and its upper limit set to ½. That is, when ⅖≦θτ≦½, the torque T is higher than or equal to the threshold value Ttha. In addition, setting the pole arc ratio θr to be less than or equal to ½, it is possible to impart a regular saliency to the magnetic pole portions 13b of the rotor core 13a.

FIG. 8 illustrates the relationship between a width ratio Wr and the torque T of the synchronous rotating electric machine 10.

The width ratio Wr is the ratio of the narrow width Wa to the yoke width Wb (see FIG. 2). That is, Wr=Wa/Wb.

In FIG. 8, the horizontal axis represents the width ratio Wr and the vertical axis represents the torque T. A characteristic line Ltb, which is drawn as a continuous line, represents the change in the torque T with the width ratio Wr. A characteristic line Lrb, which is drawn as a one-dot chain line, represents the change in the reluctance torque Tr with the width ratio Wr. A characteristic line Lmb, which is drawn as a two-dot chain line, represents the change in the magnet torque Tm with the width ratio Wr.

As shown in FIG. 8, the reluctance torque Tr increases with the width ratio Wr. In contrast, the magnet torque Tm decreases with increase in the width ratio Wr.

It can be seen from FIG. 8 that when W1≦Wr≦W2, the torque T is higher than or equal to a threshold value Tthb. In the present embodiment, W1 is set to ⅙ and W2 is set to 4/6. That is, when ⅙≦Wr≦ 4/6, the torque T is higher than or equal to the threshold value Tthb.

According to the present embodiment, it is possible to achieve the following advantageous effects.

In the present embodiment, the synchronous rotating electric machine 10 includes the armature 11 and the rotor 13. The armature 11 includes the armature core 11b and the armature coil 11a wound on the armature core 11b. The rotor 13 includes the rotor core 13a disposed in radial opposition to the armature core 11b (more specifically, disposed radially inside the armature core 11b so as to face the radially inner periphery of the armature core 11b in the present embodiment) and the permanent magnets 13m embedded in the rotor core 13a so as to be spaced from one another in the circumferential direction of the rotor core 13a. Moreover, the rotor 13 has a structure such that: the rotor core 13a has the yoke portions 13c each of which is formed between one circumferentially-adjacent pair of the permanent magnets 13m; and all of the permanent magnets 13m are magnetized in the same magnetization direction D along the circumferential direction of the rotor core 13a so that for each circumferentially-facing pair of the circumferential side surfaces of the permanent magnets 13m, the polarities of the circumferential side surfaces of the circumferentially-facing pair are opposite to each other (see FIG. 2). With the above structure, the flow of the magnetic flux generated by the permanent magnets 13m in the synchronous rotating electric machine 10 changes depending on whether the armature current is flowing in the armature coil 11a.

Consequently, it becomes possible to change the flow of the permanent magnet magnetic flux (i.e., the magnetic flux generated by the permanent magnets 13m) in the synchronous rotating electric machine 10 only by controlling supply of the armature current to the armature coil 11a without providing a field winding in the rotor 13. As a result, it becomes possible to reduce the parts count and thus the manufacturing cost of the synchronous rotating electric machine 10; it also becomes possible to minimize the size of the rotor 13 and thus the size of the entire synchronous rotating electric machine 10. Moreover, it is possible to adjust the amount of the permanent magnet magnetic flux crossing the armature coil 11a by changing the magnetomotive force generated in the armature coil 11a through changing the amplitude of the armature current. Accordingly, compared to conventional rotating electric machines where the armature coil is always subject to the permanent magnet magnetic flux, it is possible to secure a high output (e.g., high torque T) of the synchronous rotating electric machine 10 in a wide rotational speed range by suitably adjusting the amount of the permanent magnet magnetic flux crossing the armature coil 11a.

Moreover, in the present embodiment, when no current is flowing in the armature coil 11a, the permanent magnet magnetic flux circumferentially circulates in the rotor core 13a through the yoke portions 13c of the rotor core 13a (see FIG. 4). On the other hand, when the armature current is flowing in the armature coil 11a, part of the permanent magnet magnetic flux is attracted, by the magnetomotive force generated in the armature coil 11a, to flow to the armature 11 through the yoke portions 13c of the rotor core 13a (see FIG. 5).

With the above configuration, when no current is flowing in the armature coil 11a, the permanent magnet magnetic flux circumferentially circulates through the first magnetic circuit in the rotor core 13a. Since the first magnetic circuit does not include the armature 11, there remains no permanent magnet magnetic flux in the armature core 11b. Consequently, no iron loss is caused by the permanent magnet magnetic flux in the armature core 11b. On the other hand, when the armature current is flowing in the armature coil 11a, part of the permanent magnet magnetic flux flows to the armature 11 through the second magnetic circuit. Since the second magnetic circuit includes the armature 11, the part of the permanent magnet magnetic flux (i.e., the shunt magnetic flux φs) is added to the d-axis magnetic flux φd that is generated by supplying the armature current to the armature coil 11a, increasing the main magnetic flux φm (i.e., φm=φd+φs). Consequently, with the increase in the main magnetic flux φm, the torque T of the synchronous rotating electric machine 10 is accordingly increased.

In the present embodiment, the rotor core 13a further has the magnetic pole portions 13b each of which is formed to protrude from a corresponding one of the yoke portions 13c of the rotor core 13a toward the armature 11. The magnetic pole portions 13b are spaced from one another in the circumferential direction of the rotor core 13a (see FIG. 2).

With the magnetic pole portions 13b formed in the rotor core 13a, the reluctance torque Tr is increased, thereby increasing the total torque T of the synchronous rotating electric machine 10.

In the present embodiment, the following relationship is satisfied: ⅖≦(2θa/θb)≦½, where θa is the magnetic pole angle that is defined, for each of the magnetic pole portions 13b of the rotor core 13a, as the angular range within which the distal end surface (or the radially outer end surface in the present embodiment) of the magnetic pole portion 13b circumferentially extends, and θb is the yoke angle that is defined, for each of the yoke portions 13c of the rotor core 13a, as the angular range within which the yoke portion 13c is formed (see FIGS. 3 and 7).

Satisfying the above relationship, it is possible to ensure that the torque T of the synchronous rotating electric machine 10 be sufficiently high (more specifically, higher than or equal to the threshold value Ttha as shown in FIG. 7). In addition, setting (2θa/θb) to be less than or equal to ½, it is possible to impart a regular saliency to the magnetic pole portions 13b of the rotor core 13a.

In the present embodiment, each of the yoke portions 13c of the rotor core 13a has the narrow part 13e at which the yoke portion 13c is radially narrowed (see FIG. 2).

With the narrow parts 13e of the yoke portions 13c, it is possible to limit the amount of the permanent magnet magnetic flux circumferentially circulating through the yoke portion 13c (i.e., the circulating magnetic flux φc). Consequently, it is possible to secure a sufficient amount of the permanent magnet magnetic flux flowing to the armature 11 (i.e., the shunt magnetic flux φs).

In the present embodiment, the following relationship is satisfied: ⅙≦(Wa/Wb)≦ 4/6, where Wa is the radial width of the narrow parts 13e of the yoke portions 13c of the rotor core 13a, and Wb is the radial width of other parts of the yoke portions 13c than the narrow parts 13e (see FIGS. 2 and 8).

Satisfying the above relationship, it is possible to ensure that the torque T of the synchronous rotating electric machine 10 be sufficiently high (more specifically, higher than or equal to the threshold value Tthb as shown in FIG. 8).

In the present embodiment, each of the permanent magnets 13m has the shape of a quadrangular prism with a rectangular cross section. The permanent magnets 13m are embedded in the rotor core 13a in a radial fashion so that for each of the permanent magnets 13m, the longer sides of the rectangular cross section of the permanent magnet 13m extend parallel to a radial direction of the rotor core 13a (see FIGS. 2-5).

With the above configuration, it is easy for the permanent magnet magnetic flux to circumferentially flow through the yoke portions 13c each of which is formed between one circumferentially-adjacent pair of the permanent magnets 13m. Moreover, the permanent magnets 13m can be implemented by general-purpose permanent magnets, thereby suppressing increase in the manufacturing cost of the synchronous rotating electric machine 10. In addition, it is possible to easily perform the process of embedding the permanent magnets 13m in the rotor core 13a, thereby improving the productivity.

While the above particular embodiment has been shown and described, it will be understood by those skilled in the art that various modifications, changes, and improvements may be made without departing from the spirit of the present invention.

For example, in the above embodiment, the synchronous rotating electric machine 10 is configured as an inner-rotor synchronous rotating electric machine which has the rotor 13 disposed radially inside the armature 11 so as to face the radially inner periphery of the armature 11 (see FIG. 1). However, the present invention may also be applied to an outer-rotor synchronous rotating electric machine which has a rotor disposed radially outside an armature (or stator) so as to face the radially outer periphery of the armature.

In the above embodiment, the synchronous rotating electric machine 10 is configured as a radial-gap synchronous rotating electric machine which has the armature 11 and the rotor 13 arranged to radially face each other through the radial gap G formed therebetween (see FIG. 1). However, the present invention may also be applied to an axial-gap synchronous rotating electric machine which has an armature (or stator) and a rotor arranged to axially face each other through an axial gap formed therebetween.

In the above embodiment, the number of the permanent magnets 13m is set to 8 and the number of the magnetic pole portions 13b of the rotor core 13a is set to 16. However, the number of the permanent magnets 13m may also be set to any other suitable number not less than 1 and the number of the magnetic pole portions 13b may also be set to any other suitable number not less than 2.

In the above embodiment, the permanent magnets 13m each have the rectangular cross section and are embedded in the rotor core 13a in the radial fashion so that for each of the permanent magnets 13m, the longer sides of the rectangular cross section of the permanent magnet 13m extend parallel to the radial direction of the rotor core 13a (see FIG. 2). However, the permanent magnets 13m may alternatively have other cross-sectional shapes, such as a polygonal cross-sectional shape other than the rectangular cross-sectional shape (e.g., a triangular or pentagonal cross-sectional shape), a circular cross-sectional shape, an elliptical cross-sectional shape or a cross-sectional shape that is a combination of a plurality of different cross-sectional shapes. Moreover, the permanent magnets 13m may alternatively be embedded in the rotor core 13a in other postures, such as a posture of having the longer sides of the rectangular cross section extending along the circumferential direction of the rotor core 13a or a posture of having the longer sides of the rectangular cross section extending obliquely with respect to the radial direction of the rotor core 13a. In any case, it is essential that the permanent magnet magnetic flux includes only the circulating magnetic flux φc when no current is flowing in the armature coil 11a (see FIG. 4) and both the circulating magnetic flux φc and the shunt magnetic flux φs when the armature current is flowing in the armature coil 11a (see FIG. 5).

In the above embodiment, each of the permanent magnets 13m embedded in the rotor core 13a is formed in one piece. However, at least one of the permanent magnets 13m may alternatively be comprised of a plurality of permanent magnet segments.

In the above embodiment, the armature coil 11a is configured as a three-phase coil. However, the number of phases of the armature coil 11a may be greater than 3.

In the above embodiment, the hub portion 13d of the rotor core 13a is formed separately from and fixed to the rotating shaft 15. However, in cases where the rotating shaft 15 is formed of a nonmagnetic material, the hub portion 13d may alternatively be formed integrally with the rotating shaft 15 into one piece. Moreover, the hub portion 13d may be shaped into a cylinder without spoke parts.

In the above embodiment, the synchronous rotating electric machine 10 is configured as a synchronous electric motor. However, the present invention may also be applied to other synchronous rotating electric machines, such as a synchronous electric generator or a synchronous motor-generator that can selectively function either as a synchronous electric motor or as a synchronous electric generator.

What is claimed is:

1. A synchronous rotating electric machine comprising:
an armature including an armature core and an armature coil wound on the armature core; and
a rotor including a rotor core disposed in radial opposition to the armature core and a plurality of permanent magnets embedded in the rotor core so as to be spaced from one another in a circumferential direction of the rotor core,
wherein
the rotor has a structure such that:
the rotor core has a plurality of yoke portions each of which is formed between one circumferentially-adjacent pair of the permanent magnets; and
all of the permanent magnets are magnetized in a same magnetization direction along the circumferential direction of the rotor core so that for each circumferentially-facing pair of circumferential side surfaces of the permanent magnets, polarities of the circumferential side surfaces of the circumferentially-facing pair are opposite to each other, and
with the structure of the rotor, flow of magnetic flux generated by the permanent magnets changes depending on whether electric current is flowing in the armature coil.

2. The synchronous rotating electric machine as set forth in claim 1, wherein when no electric current is flowing in the armature coil, the magnetic flux generated by the permanent magnets circumferentially circulates in the rotor core through the yoke portions of the rotor core, and
when electric current is flowing in the armature coil, part of the magnetic flux generated by the permanent magnets is attracted, by magnetomotive force generated in the armature coil, to flow to the armature through the yoke portions of the rotor core.

3. The synchronous rotating electric machine as set forth in claim 1, wherein the rotor core further has a plurality of magnetic pole portions each of which is formed to protrude from a corresponding one of the yoke portions of the rotor core toward the armature, the magnetic pole portions being spaced from one another in the circumferential direction of the rotor core.

4. The synchronous rotating electric machine as set forth in claim 3, wherein ⅖≦(2θa/θb)≦½, where
θa is a magnetic pole angle that is defined, for each of the magnetic pole portions of the rotor core, as an angular range within which a distal end surface of the magnetic pole portion circumferentially extends, and
θb is a yoke angle that is defined, for each of the yoke portions of the rotor core, as an angular range within which the yoke portion is formed.

5. The synchronous rotating electric machine as set forth in claim 1, wherein each of the yoke portions of the rotor core has a narrow part at which the yoke portion is radially narrowed.

6. The synchronous rotating electric machine as set forth in claim 5, wherein ⅙≦(Wa/Wb)≦ 4/6, where
Wa is a radial width of the narrow parts of the yoke portions of the rotor core, and
Wb is a radial width of other parts of the yoke portions than the narrow parts.

7. The synchronous rotating electric machine as set forth in claim 1, wherein each of the permanent magnets has the shape of a quadrangular prism with a rectangular cross section, and
the permanent magnets are embedded in the rotor core in a radial fashion so that for each of the permanent magnets, the longer sides of the rectangular cross section of the permanent magnet extend parallel to a radial direction of the rotor core.
